(19) United States
(12) Patent Application Publication
(10) Pub. No.: US 2020/0320210 A1
(43) Pub. Date: Oct. 8, 2020

(54) DATABASE WITH SECURITY ROW TABLES

(71) Applicant: International Business Machines Corporation, Armonk, NY (US)

(72) Inventors: Artur M. Gruszecki, Krakow (PL); Tomasz Kazalski, Balice (PL); Tomasz Sekman, Krakow (PL); Michal Bodziony, Tegoborze (PL); Rafal Korczyk, Bielsko-Biala (PL)

(21) Appl. No.: 16/377,376

(22) Filed: Apr. 8, 2019

(51) Int. Cl. G06F 21/62; G06F 16/903; G06F 16/901

(52) U.S. Cl. CPC G06F 21/6218; G06F 16/9027; G06F 16/903

(57) ABSTRACT

A computer-implemented method for processing a query for accessing data in a database with row level security may be provided. The data is organized in rows and columns, and the rows are grouped in storage regions. The method comprises maintaining, as part of a control record for each storage region, a lower access security label, representing a minimal user access right of any of the rows in the storage region, and an upper access security label representing a maximal user access right of any of the rows in the storage region, and upon determining, for a query, whether an access right of a user initiating the query is below the lower access security label of a storage region addressed by the query, skipping the storage region during a read execution of the query.

### FIELD OF THE INVENTION

The invention relates generally to a method for processing a query for a database, and more specifically, to a computer-implemented for processing a query for accessing data in a database with row level security. The invention relates further to a related database system, and a computer program product.

### BACKGROUND

Storing data securely continues to be one of the key objectives of enterprise IT (information technology) organizations. Concepts like data warehousing, large data, cross-functional analytics, continuous learning, and similar require storing more and more data from daily business operations, as well as machine data and/or the operational data supporting concepts like Industry 4.0 (aka Internet-of-Things). In many cases databases, in particular relational databases, are used for storing the data mentioned above. Because of cross-functional and cross-application access to these data (e.g., for analytical tasks) controlling and securing access to the data, in particular in light of governmental requirements, e.g., GDPR (general data protection regulation) of the European Union becomes paramount. Special considerations regarding data privacy need to be made. One of the concepts supporting multilevel security of high granularity and data access is known as row-level security.

The database feature known as row-secure tables (RST) has been introduced into database systems for enhanced data access control. In short, the row-secure table can be seen as a table with security labels per row used to filter out data (rows) based on defined user privileges. Currently in the art, two users, with different privileges obtain a different set of the rows of the same structured query language (SQL) executed against the same RST at the same time. Different database vendors are using different ways of defining the control access privileges for RSTs. One of the different ways of defining the control access privileges for RSTs is implementing the abstract security model known as Multi-Level Security (MLS). In some instances, more than one dimension of security labels may be maintained which may be applied separately or together to a single row in a relational database.

### SUMMARY

Embodiments of the present invention disclose a method, a computer program product, and a system for processing a query for accessing data in a database with row level security, wherein said data being organized in rows and columns, wherein rows are grouped in storage regions. A computer-implemented method includes maintaining, as part of a control record for each storage region, a lower access security label, representing a minimal user access right of any of said rows in said storage region, and an upper access security label representing a maximal user access right of any of said rows in said storage region; and upon determining, for a query, whether an access right of a user initiating said query is below said lower access security label of a storage region addressed by said query, skipping said storage region during a read execution of said query.

### BRIEF DESCRIPTION OF THE DRAWINGS

FIG. 1 shows a block diagram of an embodiment of the inventive computer-implemented method for processing a query for accessing data in a database with row level security;

FIG. 2 shows tables and hierarchical diagrams instrumental for describing multi-level security concept;

FIG. 3 shows a block diagram of an embodiment of the database system for processing a query for accessing data in a database with row level security; and

FIG. 4 shows an embodiment of a computing system comprising the database system according to FIG. 3.

### DETAILED DESCRIPTION

Currently, there are drawbacks to the current solutions in the art: the throughput-performance of such tightly secured database accesses is reduced significantly. For large row-secure tables, the response time can be significantly worse than for similar tables without that feature.

Disadvantages of known solutions in the art continue to have a negative impact on the database performance. Thus, embodiments of the present invention overcome the conflict described above between row-level, multi-level and multi-dimensional secure data access, on one side, and high-performance requirements, on the other side. Embodiments of the present invention can improve the art of processing a query for accessing data in a database with row level security by using an alternative representation of the security model for cohort and category; modifying low-level statistics called “zone maps” by adding a field for each extent representing the MLS dimension; modifying the way of reading table content based on the new feature added into zone maps; modifying administrative tasks responsible for calculating low-level statistics; and modifying user description inside the database dictionary.

Embodiments of the present invention for processing a query for accessing data in a database with row level security may offer multiple advantages and technical effects.

Generally, the so far diverging objectives (i.e., row-level security and high performance) for relational databases may be overcome. To achieve this, the control record for each storage region, i.e., also denoted as extent, is expanded with data not visible and accessible with regular user SQL statements. However, the database engine is using additional control data, in particular the lower access security label and the upper access security label.

The additional control data fields, stated above, may be maintained automatically by the database management system and re-present the minimum and the maximum user access right of all rows in a given storage region. Thus, when accessing a storage region comprising a plurality of database records, i.e., rows, the database security control system may instantly determine whether it may be required to access the rows in the storage region and determine access rights row by row or to skip the storage region completely (e.g., skipping a row security table examination).

In various embodiments, depending on the number of rows, the amount of individual determinations (i.e., time-consuming if-then commands) hence, a large number of individual decisions regarding individual data access to individual rows may be replaced by a single determination. The impact of such a concept is that the performance of row-secure tables may be increased significantly and overcomes the known dilemma of traditional row-secure databases between row-level security and high-performance database operations.

Additionally, the proposed concept may also be implemented as a multi-dimensional security concept for database rows. In particular, the concepts of linear user access rights, category access rights and cohort access rights may be implementable using the same underlying idea of expanding the control record for a storage region. Thus, the already successfully used multi-level security concepts may also be used within the proposed concept.

Consequently, applications, defined SQL statements, traditionally used database queries in any form, data analytic concepts, and so on may be used unchanged while experiencing the newly possible high-performance operation of a database with row-level security.

According to one preferred embodiment of the method, in each of the storage regions a number of rows are stored. Each storage region may be defined by a block size of the database storage. Depending on a length of the rows, a maximum number of rows (i.e., records) may be fitted into each of the storage regions. The storage system may physically be implemented as, e.g., physical disk, flash memory, or a tape archive. The block size may be adjustable or may depend on the used technology and/or may eventually also be defined by operating system.

In the context of this description, the following conventions, terms and/or expressions may be used.

The term ‘query’ may denote a statement for a data access to a database using a database engine and using a data query language, e.g., SQL (structured query language).

The term ‘database’ may denote here a system for a management of data, in particular in rows, i.e., database records and columns, i.e., a relational database management system.

The term ‘row level security’ may denote the concept that for every row in the database individual access rights for users may be defined and maintained.

The term ‘storage regions’ may denote a group of database rows that may be manageable together. The size of the storage region may be identical to a block size of an underlying storage system like a spinning disk, a flash memory system or a tape archive system. The term storage region may also be denoted as extent.

The term ‘lower access security label’ may denote an additional database management field maintained as part of a control record for each storage region.

The term ‘access right’ may denote the allowance or privilege to read, write or delete data in a data storage system, e.g., a database system. Access rights may be defined for a user or another system, e.g., an application according to a variety of different dimensions, e.g., per table, per column, per row, per record, per time frame, and so on. The concept of row-level security, as a special access right concept, may play a predominant role in this document. The concept described above may be used in a highly complex database management systems in order to ensure and implement data privacy regulations.

The term ‘upper access security label’ may denote the highest access security label in particular, per dimension for a group of rows, or for a given storage region. Thus, instead of determining each security setting for each row in a storage region, a single access to the upper access security label may be sufficient in order to determine whether it makes sense to go row by row through the storage region or skip it completely.

The term ‘block size’ may denote the size of a physical or logical storage block of a storage device. Typical block sizes may be 4 kilobyte, 8 kilobyte or 16 kB. Block identity documents (IDs) may be used for a quick navigation within a storage device.

The term ‘level access right’ may denote a linearly organized access right, typically using integer values, to differentiate access rights of users. The granularity of the level access rights may depend on the type of database. A typical coarse-grain categorization may be PUBLIC, CURRENT, SECURE, OMNI.

The term ‘category access right’ may denote an all-of-tag security concept (i.e., a bitwise AND of the security bits). A user with a security profile and defined access tags may access a database row that has all tags attached to the row. For example, category access rights may be denoted as PUB, AUDIT, SUPER, OMNI. In various embodiments, the category access right may be a set of all-of-tag, implemented as a bitmap. Thereby, the user access rights of a user, initiating the query, must match all bits of the bitmap in order to access a related row. This concept may enable a bitwise management of access rights that can be advantageous if compared to a simpler linear access right management with only an integer value.

The term ‘cohort access right’ may denote an any-of-tag security concept (i.e., a bitwise OR of the security bits). It may be well suited to manage a hierarchical data access concept. In various embodiments, the cohort access right may be a set of any-of-tag, implemented as a bitmap, wherein the user access rights of a user, initiating the query, must match at least one bit of the bitmap in order to access a related row. This additional bitwise access right management implements the bit-level access control management in another dimension. Thus, in various embodiments, the concept of all-of-tag and any-of tag may be combinable in one single access right management.

The term ‘control record’, in particular, the control record of the storage region, may denote a so-called zone map of an extent, i.e., a storage region. The zone map may comprise security settings and control information about a storage region. According to the proposed concept the zone map may comprise additional fields, like the upper access security label and the lower security label.

In the following, a detailed description of the figures will be given. The instructions in the figures are schematic. Firstly, a block diagram of an embodiment of the inventive computer-implemented method for processing a query for accessing data in a database with row level security is given. Afterwards, further embodiments, as well as embodiments of the database system for processing a query for accessing data in a database, will be described.

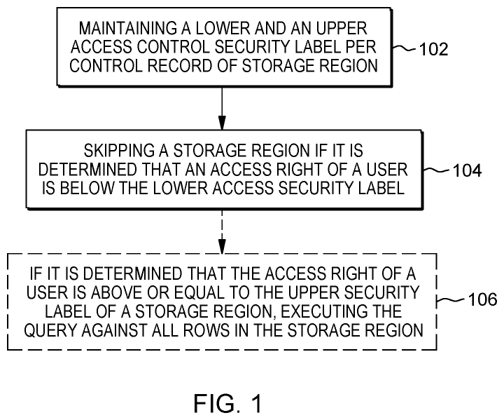

FIG. 1 shows a block diagram of an embodiment of the computer-implemented method for processing a query for accessing data in a database, in particular a relation database, with row level security. The data is typically organized in rows and columns, and the rows are grouped in storage regions, in particular, the so-called extents.

The method comprises maintaining, 102, as part of a control record for each storage region, a lower access security label, representing a minimal user access right of any of the rows in the storage region, and an upper access security label representing a maximal user access right of any of the rows in the storage region, and upon determining, for a query, whether an access right of a user, in particular represented by a user ID with a user security profile, initiating the query is below the lower access security label of a storage region addressed by the query, skipping, 104, the storage region during a read execution of the query (e.g., skipping a row security table examination).

As an extension a third block 106 is shown in dashed lines illustrating an extension of the above-described underlying concept: if it is determined that the access right of a user query is above or equal to the upper security label of a storage region, it may be needless to determine the access right of the user query again and again for every row of the storage region. Performance-wise it is instrumental to skip on these individual determinations on a row level and simply execute the query against rows in the storage region. In various embodiments, if it is determined that the access right of a user query is above or equal to the upper security label of a storage region, the query against a plurality of rows in the storage region can be executed.

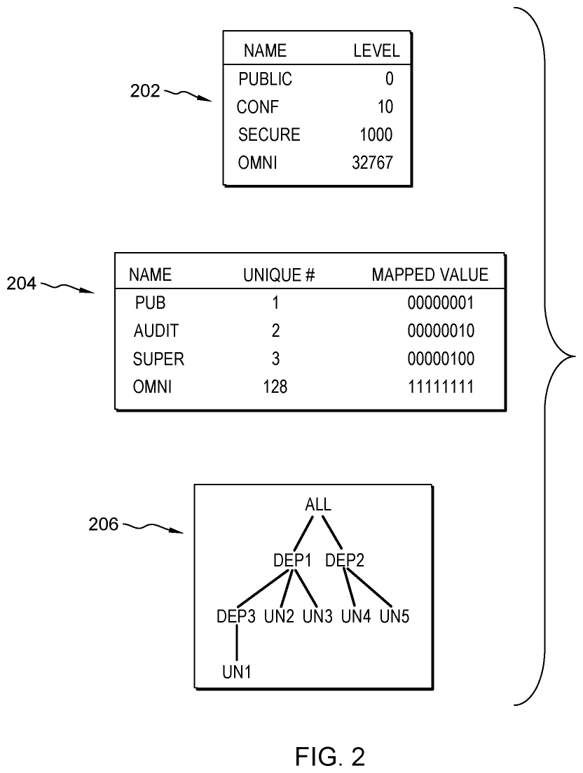

FIG. 2 shows tables and hierarchical diagrams instrumental for describing a multi-level security concept. Table 202 shows a simple level structure. In this particular embodiment, four levels of increasing user access privileges are defined as: PUBLIC, CONF, SECURE, OMNI. In this particular embodiment, the related access security levels are 0, 10, 1000 and 32767. In this example, the granularity of the access right levels may be limited to 2¹⁵ different levels from which only four are named as an example. The level values are integer values: e.g., zero, ten, one-thousand and thirty-two thousand seven hundred sixty-seven.

Table 204 illustrates the concept of the category access right. In this particular embodiment, four categories of increasing user access privileges are defined: PUB, AUDIT, SUPER, OMNI. The second column of this table shows a unique number, whereas the third column shows the binary map value of the category all-of-tag access right. If the user intends to access a database record, i.e., a row with a security value of 100 (binary), the user access right must show exactly this setting, i.e., the user must have the SUPER access right.

Table 206 illustrates the concept of the cohort access right. It is shown using the example of an organizational hierarchy of departments and units. The dependencies between the departments and units are shown using straight lines. For example, if a user has access to the data of department DEP3, the user also has access to the data of unit UN1. If a user may have access to the data, for example, rows comprising tags relating to department DEP1, the user may also have access to the data of the departments DEP3, UN2, UN3 and also UN1. The cohort access right is organized as any-of-tag.

Generally, the mapping of access rights may be done using the following rules: (i) each leaf in the cohort tree has a unique binary code assigned; (ii) the nodes above each leaf are represented as bits obtained from a bitwise OR of each leaf on nodes below them. As an example: DEP3=00001, DEP2, =11000, DEP1=00111, and ALL=11111.

The following examples will illustrate different options using this multi-level security concept together with the proposed general concept of the high-performance database access to storage regions.

If, for example, for a given storage region/extent the following rows exist:
Row_1 with access level 10,
Row_2 with access level 10,
Row_3 with access level 1000, then
the lower access security label is 10 and the upper access security label has the value 1000.

A similar example for the category access right follows for a storage region/extent:
Row_1 with category PUB 00000001,
Row_2 with category PUB 00000001,
Row_3 with category AUDIT 00000010, then
the zone map for the category of this extent would be 00000011.

Another example for the cohort access right follows for a storage region/extent:
Row_1 with cohort UN1 00001,
Row_2 with cohort UN2 00010,
Row_3 with cohort DEP1 00111, then
the zone map for the cohort of this extend would be 00111.

The multi-level security concept together with the proposed general concept of the high-performance database access to storage regions described above have consequences to a read access to the storage region. The way of filtering the storage regions is modified in a way that the rows are partially omitted completely during reading, depending on the setting of the access right of a user in comparison to the lower and upper access security label of the control record of a specific storage region.

The following example may make the multi-level security concept together with the proposed general concept of the high-performance database access to storage regions described above better comprehensible:
User level public=level 0

### Extent 11

Row 1: level 10
Row 2: level 10
Row 3: level 1000
lower access security label: 10 for Extent 11

### Extent 12

Row 1: level 0
Row 2: level 10
Row 3: level 1000
lower access security label: 0 for Extent 12

Accordingly, extent 11 will be omitted and extent 12 will be qualified to be read by a public user because the public user access right is below the lower access security label of extent 11 and above the lower access security label of extent 12.

For a category access right, the extent is omitted if the user access right categories are not matched completely. For example, three users may be imagined:
user 1 with category access right PUB, mask 00000001,
user 2 with category access right SUPER, mask 00000100,
user 3 with category access right OMNI, mask 1111111.

The following storage region/extent 20 may also be assumed:
Row 1: category SUPER 00000100,
Row 2: category SUPER 00000100,
Row 3: category AUDIT 00000010.
In this case, the storage region 20 will be omitted for user 1 and read by user 2 and 3.

For the cohort access right, the storage region would be omitted if the user cohort access right is not found in the extent, i.e., control record of the storage region. For example, two users may be imagined:
user 1 with cohort DEP3, mask 00001,
user 2 with cohort DEP2, mask 11000.

A storage region 30 may have the following rows:
Row 1: cohort UN1 00001,
Row 2: cohort UN2 00010,
Row 3: cohort DEP1 00111.
The zone map for the related cohort in extent 30 is: 00111.

A storage region 31 may have the following rows:
Row 1: cohort UN4 01000,
Row 2: cohort UN5 10000,
Row 3: cohort DEP2 11000.
The zone map for the related cohort in extent 31 is: 11000.

The result of a read access would be:
For user 1 the storage region 30 will be read any storage region 31 will be omitted.
For user 2 the storage region 31 will be read any storage region 30 will be omitted.

It may also be mentioned that new the new field in the control record for a storage region may require additional calculations/determinations for administrative tasks of the database system responsible for creating and maintaining the additional data field in the control record. This is not be required for every modification of rows in the storage regions but may be delayed for a next grooming process.

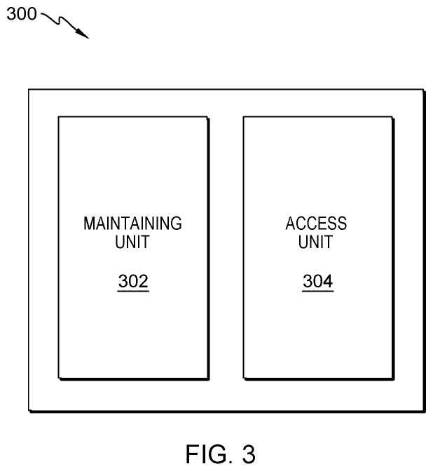

FIG. 3 shows a block diagram of an embodiment of the database system 300 for processing a query for accessing data in a database with row level security. The data is typically organized in rows and columns, wherein rows are grouped in storage regions, i.e., a relational database system with extent management. The system comprises a maintaining unit 302 adapted for maintaining, as part of a control record for each storage region, a lower access security label, representing a minimal user access right of any of the rows in the storage region, and an upper access security label representing a maximal user access right of any of the rows in the storage region. Additionally, the database system 300 comprises an access unit 304 adapted for: upon determining, for a query, whether an access right of a user initiating the query is below the lower access security label of a storage region addressed by the query, skipping the storage region during a read execution of the query. In various embodiments, database system 300 can maintain additional metadata structure for each user to store a summary of MLS information for the user, for example, level, category mask (e.g., bit summary of one or more categories assigned to the user), and cohort mask (e.g., bit summary of one or more cohorts assigned to the user).

According to one useful embodiment, the access right of a user, initiating the query, may be organized as level access right, as category access right and/or as cohort access right. The multi-dimensional access management may equip the method with the advantageous multi-level access right and multi-level security concept.

According to one optional embodiment, the level access right may be maintained as an integer value, i.e., a value between, e.g., 0 and 32767. Thus, 2¹⁵ different access right levels may be differentiated. However, any other digital value may be as useful as the described integer value.

According to one advantageous embodiment, for each of the multi-level security dimensions (i.e., level, category, and/or cohort a new data field) in particular, invisible fields to a user of the row or record, may be added to a zone map of a storage region. Thus, each row may be extended by the access right information which, on the other side, can be invisible or inaccessible by a user directly. In this particular embodiments, only the database management control and security system may advantageously use this additional access right information.

According to one preferred embodiment, embodiments of the present invention can maintain the access rights of a user by maintaining: (i) a level value, (ii) a category mask, comprising a bitmap summary of all categories assigned to a user, and (iii) a cohort mask, comprising a bitmap summary of all cohorts assigned to a user. All of the access right data may each be comprised in a privilege record to be used by a security system.

According to another advantageous embodiment, omitting a storage range during reading as part of the query if one of the following conditions is met comprises: (i) a user's level is below a minimal level of the storage region, (ii) a user's category is not matched, in particular to the all-of-tag concept, or (iii) a user's cohort is not found in the storage region. Hence, a straight forward and easy to maintain and understandable security concept may be implemented on a row level in a database system or database engine with significantly increased performance advantages if compared to traditional row level security concepts.

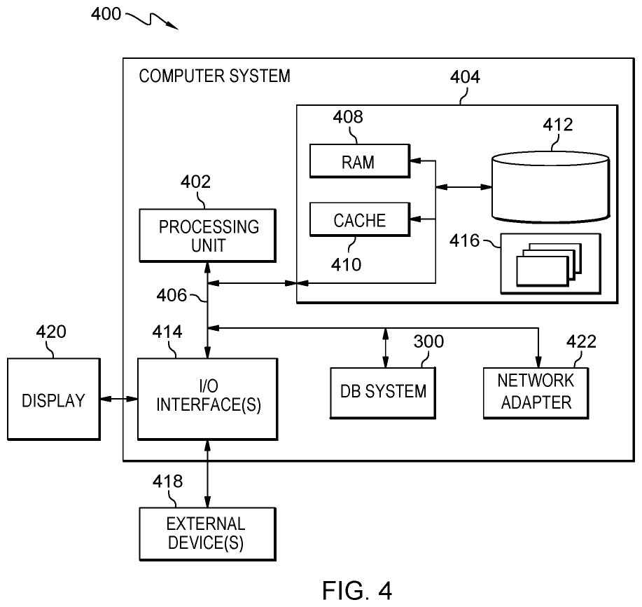

Embodiments of the invention may be implemented together with virtually any type of computer, regardless of the platform being suitable for storing and/or executing program code. FIG. 4 shows, as an example, a computing system 400 suitable for executing program code related to the proposed method.

The computing system 400 is only one example of a suitable computer system, and is not intended to suggest any limitation as to the scope of use or functionality of embodiments of the invention described herein, regardless, whether the computer system 400 is capable of being implemented and/or performing any of the functionality set forth hereinabove. In the computer system 400, there are components, which are operational with numerous other general purpose or special purpose computing system environments or configurations. Examples of well-known computing systems, environments, and/or configurations that may be suitable for use with computer system/server 400 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 400 may be described in the general context of computer system-executable instructions, such as program modules, being executed by a computer system 400. Generally, program modules may include routines, programs, objects, components, logic, data structures, and so on that perform particular tasks or implement particular abstract data types. Computer system/server 400 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 400 is shown in the form of a general-purpose computing device. The components of computer system/server 400 may include, but are not limited to, one or more processors or processing units 402, a system memory 404, and a bus 406 that couple various system components including system memory 404 to the processing units 402. Bus 406 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 400 typically includes a variety of computer system readable media. Such media may be any available media that is accessible by computer system/server 400, and it includes both, volatile and non-volatile media, removable and non-removable media.

The system memory 404 may include computer system readable media in the form of volatile memory, such as random access memory (RAM) 408 and/or cache memory 410. Computer system/server 400 may further include other removable/non-removable, volatile/non-volatile computer system storage media. By way of example only, a storage system 412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 406 by one or more data media interfaces. As will be further depicted and described below, memory 404 may include at least one program product having a set (e.g., at least one) of program modules that are configured to carry out the functions of embodiments of the invention.

The program/utility, having a set (at least one) of program modules 416, may be stored in memory 404 by way of example, and not limiting, as well as an operating system, one or more application programs, other program modules, and program data. Each of the operating systems, one or more application programs, other program modules, and program data or some combination thereof, may include an implementation of a networking environment. Program modules 416 generally carry out the functions and/or methodologies of embodiments of the invention, as described herein.

The computer system/server 400 may also communicate with one or more external devices 418 such as a keyboard, a pointing device, a display 420, etc.; one or more devices that enable a user to interact with computer system/server 400; and/or any devices (e.g., network card, modem, etc.) that enable computer system/server 400 to communicate with one or more other computing devices. Such communication can occur via Input/Output (I/O) interfaces 414. Still yet, computer system/server 400 may communicate with one or more networks such as a local area network (LAN), a general wide area network (WAN), and/or a public network (e.g., the Internet) via network adapter 422. As depicted, network adapter 422 may communicate with the other components of the computer system/server 400 via bus 406. It should be understood that, although not shown, other hardware and/or software components could be used in conjunction with computer system/server 400. Examples, include, but are not limited to: microcode, device drivers, redundant processing units, external disk drive arrays, RAID systems, tape drives, and data archival storage systems, etc.

Additionally, the database system 300 for processing a query for accessing data in a database maybe attached to bus 406.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for processing a query for accessing data in a database with row level security, wherein said data being organized in rows and columns, wherein rows are grouped in storage regions, said method comprising:
maintaining, as part of a control record for each storage region, a lower access security label, representing a minimal user access right of any of said rows in said storage region, and an upper access security label representing a maximal user access right of any of said rows in said storage region; and
upon determining, for a query, whether an access right of a user initiating said query is below said lower access security label of a storage region addressed by said query, skipping said storage region during a read execution of said query.

2. The computer-implemented method according to claim 1, wherein in each of said storage regions a number of rows is stored, defined by a block size of said database storage and a length of said rows such that a maximum number of rows fits into said storage region.

3. The computer-implemented method according to claim 1, further comprising:
upon determining for a query whether said access right of said user initiating said query is above or equal to said upper access security label of a storage region addressed by said query, executing said read query against all rows in said storage region and skipping a row security table examination.

4. The computer-implemented method according to claim 1, wherein said access right of the user initiating said query is organized as level access right, category access right and/or cohort access right.

5. The computer-implemented method according to claim 4, wherein said level access right is maintained as an integer value.

6. The computer-implemented method according to claim 5, wherein said category access right is a set of all-of-tag implemented as a bitmap, wherein said user access rights of a user initiating said query must match all bits of said bitmap in order to access said related row.

7. The computer-implemented method according to claim 6, wherein said cohort access right is a set of any-of-tag implemented as said bitmap, wherein said user access rights of the user initiating said query must match at least one bits of said bitmap in order to access said related row.

8. The computer-implemented method according to claim 7, wherein for each of the multi-level security dimensions level, category, cohort a new data field is added to a zone map of a storage region.

9. The computer-implemented method according to claim 1, further comprising:
maintaining said access rights of the user by maintaining a level value, a category mask, comprising a bitmap summary of all categories assigned to the user, and a cohort mask, comprising a bitmap summary of all cohorts assigned to the user.

10. The computer-implemented method according to claim 1, also comprising:
omitting a storage range during reading as part of said query if at least one of said following conditions is met: a user's level is below a minimal level of said storage region, a user's category is not matched, or a user's cohort is not found in said storage region.

11. A database system for processing a query for accessing data in a database with row level security, wherein said data being organized in rows and columns, wherein rows are grouped in storage regions, said system comprising:
a maintaining unit adapted for maintaining, as part of a control record for each storage region, a lower access security label, representing a minimal user access right of any of said rows in said storage region, and an upper access security label representing a maximal user access right of any of said rows in said storage region; and
an access unit adapted for: upon determining, for a query, whether an access right of a user initiating said query is below said lower access security label of a storage region addressed by said query, skipping said storage region during a read execution of said query.

12. The database system according to claim 11, wherein in each of said storage regions a number of rows is stored, defined by a block size of said database storage and a length of said records such that a maximum number of records fits into said storage region.

13. The database system according to claim 11, wherein said access unit is also adapted for: upon determining for a query whether said access right of said user initiating said query is above or equal to said upper access security label of a storage region addressed by said query, executing said read query against all rows in said storage region and skipping a row security table examination.

14. The database system according to claim 11, wherein said access right of a user initiating said query is organized as level access right, category access right and/or cohort access right.

15. The database system according to claim 14, wherein access unit is also adapted for accessing said level access right is maintained as an integer value.

16. The database system according to claim 15, wherein said category access right is a set of all-of-tag implemented as a bitmap, wherein said user access rights of a user initiating said query must match all bits of said bitmap in order to access a related row.

17. The database system according to claim 16, wherein said cohort access right is a set of any-of-tag implemented as said bitmap, wherein said user access rights of a user initiating said query must match at least one bits of said bitmap in order to access said related row.

18. The database system according to claim 17, wherein said maintaining unit is also adapted for:
for each of multi-level security dimensions level, category, cohort a new data field is added to a zone map of a storage region.

19. The database system according to claim 11, wherein said maintaining unit is also adapted for maintaining said access rights of a user by maintaining a level value, a category mask, comprising a bitmap summary of all categories assigned to said user, and a cohort mask, comprising a bitmap summary of all cohorts assigned to a user, and wherein said access unit is also adapted for omitting a storage range during reading as part of said query if at least one of the following conditions is met: the user's level is below a minimal level of said storage region, a user's category is not matched, or a user's cohort is not found in said storage region.

20. A computer program product for processing a query for accessing data in a database with row level security, wherein said data being organized in rows and columns, wherein rows are grouped in storage regions, said computer program product comprising a computer readable storage medium having program instructions embodied therewith, said program instructions being executable by one or more computing systems or controllers to cause said one or more computing systems to:
maintaining, as part of a control record for each storage region, a lower access security label, representing a minimal user access right of any of said rows in said storage region, and an upper access security label representing a maximal user access right of any of said rows in said storage region; and
upon determining, for a query, whether an access right of a user initiating said query is below said lower access security label of a storage region addressed by said query, skipping said storage region during a read execution of said query.
